(19) United States
(12) Patent Application Publication
(10) Pub. No.: US 2026/0318483 A1
(43) Pub. Date: Oct. 15, 2026

(54) METHOD FOR DISTRIBUTING A QUEUE OF TANKS TO BE FILLED IN A STATION FOR DISPENSING A PRESSURIZED GAS

(71) Applicant: L'Air Liquide, Societe Anonyme pour l'Etude et l’Exploitation des Procedes Georges Claude, Paris (FR)

(72) Inventors: Ngoc-Hau LE, Paris (FR); Guillaume MURAILLE, Paris (FR); Maxwell QUEZADA FELIZ, Paris (FR)

(21) Appl. No.: 19/640,715

(22) Filed: Apr. 7, 2026

(30) Foreign Application Priority Data
Apr. 10, 2025 (FR) FR2503810

(51) Int. Cl. F17C 5/00

(52) U.S. Cl. CPC F17C 5/007; F17C 2205/0142; F17C 2205/0326; F17C 2221/012; F17C 2250/03; F17C 2250/043; F17C 2250/0439; F17C 2250/0447; F17C 2250/0694; F17C 2265/065; F17C 2270/0168

(57) ABSTRACT

Method for distributing a queue of tanks to be filled in a station for dispensing a pressurized gas, the method comprising the following steps: for each terminal of the station connected to a tank waiting to be filled or being filled, determining S2 at a time (t₀) a specific degree of filling of said tank, for each group of terminals comprising at least one free terminal, determining S3 at the time (t₀) a degree of use of said group from an average degree of filling of the tanks connected to said group, the degree of use of the group being equal to the average degree of filling of the tanks connected to said group, from the groups having at least one free terminal, selecting S4 a group having the lowest degree of use as the group for receiving a next tank, with regard to the group selected in the selecting step S4, selecting S5 one of the free terminals as the terminal for receiving the next tank.

### CROSS REFERENCE TO RELATED APPLICATIONS

This application claims the benefit of priority under 35 U.S.C. § 119 (a) and (b) to French patent application No. FR 2503810, filed Apr. 10, 2025, which is herein incorporated by reference in its entirety.

### FIELD OF THE INVENTION

The invention relates to a method for distributing a queue of tanks to be filled in a station for dispensing a pressurized gas.

### BACKGROUND OF THE INVENTION

The dispensing station is understood primarily as being a filling centre for trailers intended to store and transport a pressurized gas. The filling station can also be understood as being a station dedicated to filling tanks for light vehicles.

A filling centre for trailers comprises a gas source, dispensing terminals which are fluidically connected to the source and are each intended to be connected to and to supply a trailer, and at least one header pipe connected upstream to the source and downstream to the dispensing terminals via parallel branches. The header pipe typically comprises an upstream end connected to the source and one or more parallel branches, the downstream ends of which are each connected to a dispensing terminal. In particular, the header pipe is provided with at least one compression member. The dispensing terminals each comprise a shut-off valve.

The filling centre also comprises a control unit configured to switch on only one terminal at a time from among the terminals connected to the same header pipe. In other words, from the source which is connected to the terminals via the header pipe, the control unit allows only one trailer filling to be carried out at a time via the terminal that has been switched on for this purpose. The control unit thus prevents any flow via the other terminals while a trailer is being filled via the switched-on terminal.

The filling centre according to the prior art comprises at most two header pipes and two compression members associated with these header pipes. For this relatively small number of header pipes, the distribution of a queue of trailers in the filling centre is managed in a non-automated way by an operator. This provides users with the signal that a terminal has become available.

In the context of the development of a new filling centre provided with a larger number of header pipes and compression members (more than two), the distribution of a queue of trailers by an operator, as has been managed to date, can very quickly reach its limits. This is because the distribution based solely on the availability of terminals does not make it possible to ensure a balanced distribution of trailers between the terminals.

### SUMMARY OF THE INVENTION

One object of the invention is to at least partially overcome this drawback.

To this end, the invention introduces a method for distributing a queue of tanks to be filled in a station for dispensing a pressurized gas.

In particular, the dispensing station comprises at least one source of pressurized gas, a plurality of dispensing terminals that are connected to the at least one gas source and are each intended to be connected to and to supply a respective tank, a plurality of separate header pipes that are connected upstream to the at least one gas source and downstream to a group of terminals via parallel branches.

Each header pipe typically comprises an upstream end connected to the at least one gas source and one or more parallel branches, the downstream ends of which are each connected to a dispensing terminal.

The station also comprises a terminal control unit, which is configured to switch on, with regard to each group of terminals, only one terminal at a time in order to fill only one tank at a time.

The method comprises, for each terminal to which a tank waiting to be filled or a tank being filled is connected, a step of determining S2 at a time (t₀) a specific degree of filling of said tank.

Moreover, the method comprises, for each group of terminals comprising at least one free terminal, a step S3 of determining at the time t₀ a degree of use of said group of terminals. This degree of use is determined from an average degree of filling of the tanks that are connected to the group of terminals and waiting to be filled or being filled. More specifically, the degree of use is equal to the average of the specific degrees of filling of the tanks that are connected to the group of terminals.

Once the degree of use has been determined for each group of terminals having at least one free terminal, the method provides a step S4 of selecting the group of terminals having the lowest degree of use as the group for receiving a next tank.

Lastly, the method provides a step S5 of selecting one of the free terminals from the group selected in step S4 as the terminal for receiving the next tank.

With the concept of the “degree of use” of a group of terminals, the invention introduces a criterion that makes it possible to better distribute the queue of tanks both between the different groups of terminals and within one and the same group of terminals.

Embodiments of the invention may have one or more of the following features:
the average degree of filling calculated with regard to each group of terminals is a ratio between: i) the sum of the specific degrees of filling of the tanks that are connected to said group of terminals and are waiting to be filled or being filled, and ii) the total number of terminals forming the group of terminals,
the method comprises, for any tank connected to a terminal and at the end of filling, that is to say for any tank that has reached a maximum specific degree of filling at the time t₀, a step S1a of assigning a zero specific degree of filling to said tank,
the degree of use of the group of terminals to which a tank is connected is determined from an average degree of filling calculated on the basis of the specific degree or degrees of filling determined in step S2 and on the basis of the zero specific degree or degrees of filling assigned in step S1a,
the method comprises, for any free terminal, a step S1b of assigning a specific zero degree of filling corresponding to an empty virtual tank connected to said terminal,
the degree of use of the group of terminals to which a free terminal belongs is determined from an average degree of filling calculated on the basis of the specific degree or degrees of filling determined in step S2 and on the basis of the zero specific degree or degrees of filling assigned in step S1b,
for any tank connected to a terminal and waiting to be filled or being filled, the specific degree of filling at the time t₀ corresponds to a ratio between a value of the density of the gas present in said tank at the time t₀ and a reference value of the density of the gas corresponding to said completely filled tank,
the value of the density of the gas in the tank at the time t₀ is determined from the pressure and the temperature of the gas that are measured in the tank using, respectively, a pressure sensor and a temperature sensor that are present in the tank,
the value of the density of the gas in the tank at the time t₀ is determined from the pressure and the temperature of the gas that are measured at the terminal to which the tank is connected,
the value of the density of the gas in the tank at the time t₀ takes into account: i) a first corrective factor representing the pressure drops associated with a supply hose fitted to the terminal to which the tank is connected, and/or ii) a second corrective factor taking into account the difference between the ambient temperature and a change in the temperature inside the tank,
the specific degree of filling of a tank determined in step S2 determines a degree of use of the terminal to which the tank is connected, the specific degree of filling of the tank being equal to the degree of use of the terminal,
the method comprises a step of estimating the future availability of a terminal on the basis of the degree of use of said terminal,
each header pipe is provided with at least one member for compressing the gas,
the groups of terminals each comprise an identical number of terminals,
the groups of terminals each comprise a different number of terminals,
the control unit comprises a set of valves distributed in the region of the terminals, and an electronic system provided with a microprocessor.

### BRIEF DESCRIPTION OF THE DRAWINGS

The invention will be understood better from reading the following description and from studying the accompanying figures. These figures are given only by way of illustration and do not in any way limit the invention.

The invention will be understood better, and further advantages will become apparent from reading the following description, with reference to the following figures, in which:

FIG. 1 schematically illustrates a dispensing station comprising at least one gas source and a plurality of terminals that are connected to the gas source and distributed in groups of two or more terminals, some terminals being available and others being connected to tanks that are being filled, at the end of filling, or waiting to be filled.

FIG. 2 illustrates the dispensing station in FIG. 1 with a second example of occupancy of the terminals.

FIG. 3 illustrates steps in the method for distributing a queue of tanks in the dispensing station illustrated in FIG. 1 and FIG. 2.

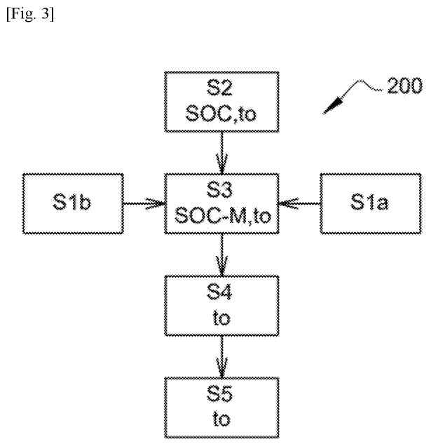

### DETAILED DESCRIPTION OF THE INVENTION

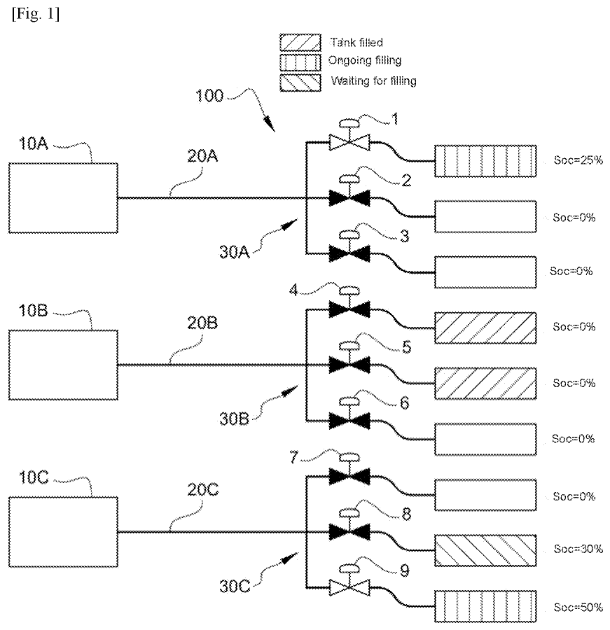

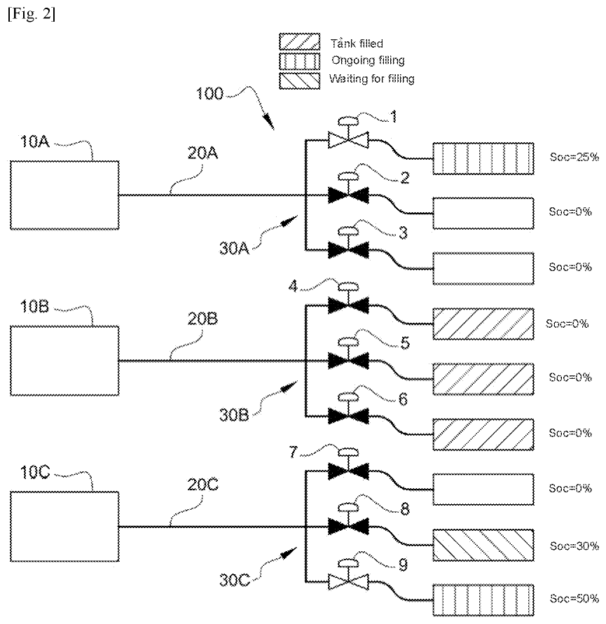

FIG. 1 and FIG. 2 illustrate a station 100 for dispensing pressurized gas. This may be a filling centre for trailers intended to store and transport pressurized gas. It may also be a filling station for tanks of light vehicles. The gas in question may be hydrogen.

The dispensing station 100 comprises at least one source 10A, 10B, 10C of pressurized gas and a plurality of dispensing terminals 1-9 which are fluidically connected to the at least one gas source 10A, 10B, 10C. In particular, the dispensing terminals 1-9 are each intended to be connected to and to supply a respective tank.

The dispensing station 100 also comprises a plurality of separate header pipes 20A, 20B, 20C which are each connected upstream to the at least one gas source 10A, 10B, 10C and downstream to a group 30A, 30B, 30C of terminals 1-3, 4-6, 7-8. In particular, the header pipes 20A, 20B, 20C are each provided with at least one compression member intended to compress a flow of gas coming from the at least one source 10A, 10B, 10C in order to transfer said flow to one of the groups 30A, 30B, 30C of terminals 1-3, 4-6, 7-8.

In the example of a station illustrated in the figures, each header pipe 20A, 20B, 20C comprises an upstream end connected to a respective gas source 10A, 10B, 10C, and three parallel branches, the downstream ends of which are each connected to a respective dispensing terminal 1-3, 4-6, 7-9. The dispensing terminals are grouped into three groups 30A, 30B, 30C. Of course, a single source could be connected to several or to all of the upstream ends of the header pipes. The dispensing terminals could be grouped in some other way.

The terminals 1-9 are connected to the associated header pipe 20A, 20B, 20C via parallel branches. Consequently, the terminals 1-3, 4-6, 7-9 forming a group 30A, 30B, 30C are also mutually parallel with respect to the associated header pipe 20A, 20B, 20C.

The dispensing station 100 also comprises a control unit for the dispensing terminals 1-9.

In particular, the control unit comprises a set of shut-off valves distributed in the region of the terminals 1-9. The shut-off valve associated with a terminal 1-9 is configured to control a flow of gas from said terminal 1-9 to a tank connected to said terminal.

The control unit also comprises an electronic system configured to send an order to open or close the respective valves of the terminals 1-9. This electronic system is equipped with a microprocessor.

With regard to each group 30A, 30B, 30C of dispensing terminals 1-9, the control unit is configured to activate only one terminal at a time by opening the associated valve, and to deactivate the other terminals by closing respective valves thereof.

In this way, only the tank connected to the activated terminal of the group 30A, 30B, 30C can be filled. The tanks connected to the deactivated terminals of the group 30A, 30B, 30C remain waiting to be filled while filling is in progress via the single activated terminal of the group 30A, 30B, 30C.

The expression “activate a terminal” is understood to mean switching the terminal on, that is to say allowing a flow of gas through said terminal in order to supply the tank connected thereto. A terminal is activated by opening the valve associated with said terminal.

The expression “deactivate a terminal” is understood to mean preventing any flow of gas through the terminal. A terminal is deactivated by closing the valve associated with said terminal.

In the examples illustrated in FIG. 1 and FIG. 2, the terminals 1-9 are distributed in three groups 30A, 30B, 30C, each comprising three terminals 1-3, 4-6, 7-9. Moreover, three separate gas sources 10A, 10B, 10C are provided, and three separate header pipes 20A, 20B, 20C each connect a group 30A, 30B, 30C of terminals 1-3, 4-6, 7-9 to a gas source 10A, 10B, 10C. Lastly, three compression members (not illustrated) are provided for these three header pipes 20A, 20B, 20C, with one compression member per header pipe 20A, 20B, 20C.

However, a number of groups 30A, 30B, 30C of terminals greater than three can be envisaged. Similarly, it is possible to envisage groups of terminals each having a different number of terminals.

In order to distribute a queue of tanks in the dispensing station 100, the invention introduces a method 200, the steps of which are described below.

For each terminal 1-9 to which a tank waiting to be filled or being filled is connected, the method 200 provides a step S2 of determining at a time t₀ a specific degree of filling SOC of said tank.

The specific degree of filling SOC of the tank determines a degree of use of the terminal 1-9 to which the tank is connected. More specifically, the degree of use of the terminal 1-9 is equal to the specific degree of filling SOC of the tank which is connected thereto.

Moreover, for each group 30A, 30B, 30C of terminals 1-3, 4-6, 7-9 comprising at least one free terminal, the method 200 provides a step S3 of determining, at the time t₀, a degree of use of said group 30A, 30B, 30C.

The degree of use of a group 30A, 30B, 30C of terminals 1-3, 4-6, 7-9 is determined from an average degree of filling SOC-M of the tanks which are connected to the terminals of this group 30A, 30B, 30C and waiting to be filled or being filled. More specifically, the degree of use of a group 30A, 30B, 30C of terminals 1-3, 4-6, 7-9 is equal to the average degree of filling SOC-M of tanks connected to this group 30A, 30B, 30C of terminals 1-3, 4-6, 7-9.

Once the degrees of use have been determined for the various groups 30A, 30B, 30C of terminals 1-3, 4-6, 7-9 having at least one free terminal, the method 200 provides a step S4 of selecting a group 30A, 30B, 30C of terminals 1-3, 4-6, 7-9 having the lowest degree of use as the group 30A, 30B, 30C for receiving a next tank.

Lastly, from the group 30A, 30B, 30C selected in step S4, the method 200 provides a step S5 of selecting the free terminal as the terminal for receiving the next tank.

When several terminals are free in the group 30A, 30B, 30C selected in step S4, the selection in step S5 can be based on a predefined criterion, such as the order or the number of terminals.

Thus, a lower order free terminal can be chosen to receive the next tank to be filled instead of a higher order free terminal. Alternatively, an even-numbered free terminal can be chosen to receive the next tank on even days, and an odd-numbered free terminal can be chosen to receive the next tank on odd days.

It should be noted that, for any tank connected to a terminal 1-9 and waiting to be filled or being filled, the specific degree of filling SOC of this tank at the time t₀ corresponds to a ratio between a value of the density of the gas present in said tank at the time t₀ and a reference value of the density of the gas corresponding to said completely filled tank.

The value of the density of the gas in the tank can be determined from the pressure and the temperature of the gas that are measured in the tank using, respectively, a pressure sensor and a temperature sensor that are present in the tank.

As a variant, the value of the density of the gas in the tank can be determined from the pressure and the temperature of the gas that are measured at the terminal 1-9 to which the tank is connected.

According to this variant, the value of the density of the gas in the tank may take into account a first corrective factor representing the pressure drops associated with a supply hose connecting the tank to the dispensing terminal. The value of the density may also take into account a second corrective factor taking into account the difference between the ambient temperature and a change in the temperature inside the tank.

It should also be noted that the average degree of filling SOC-M calculated over the tanks connected to the terminals 1-3, 4-6, 7-9 of a group 30A, 30B, 30C (this degree of filling being equal to the degree of use of this group 30A, 30B, 30C of terminals 1-3, 4-6, 7-9) is a ratio between: i) the sum of the specific degrees of filling SOC of the tanks that are connected to the group 30A, 30B, 30C of terminals 1-3, 4-6, 7-9 and waiting to be filled or being filled, and ii) the total number of terminals 1-3, 4-6, 7-9 that form the group 30A, 30B, 30C.

For a tank at the end of filling, that is to say a tank which has reached a maximum specific degree of filling SOC (i.e. SOC=100%), and which is still connected to a terminal 1-9, the method 200 provides a step S1a of assigning a zero specific degree of filling SOC to such a tank (i.e. SOC=0%).

The degree of use of the group 30A, 30B, 30C of terminals 1-3, 4-6, 7-9 to which such a tank is connected is then determined from an average degree of filling SOC-M calculated on the basis of the specific degree or degrees of filling SOC determined in step S2 and on the basis of the zero specific degree or degrees of filling SOC (i.e. SOC=0%) assigned in step S1a.

Similarly, for any free terminal 1-9 (that is to say a terminal to which no tank is connected), the method 200 provides a step S1b of assigning a zero specific degree of filling SOC (i.e. SOC=0%) corresponding to an empty virtual tank which would be connected to this terminal 1-9.

The degree of use of the group 30A, 30B, 30C of terminals 1-3, 4-6, 7-9 to which such a terminal 1-9 belongs is determined from an average degree of filling SOC-M calculated on the basis of the specific degree or degrees of filling SOC determined in step S2 and on the basis of the zero specific degree or degrees of filling SOC (i.e. SOC=0%) assigned in step S1b.

As indicated above, the specific degree of filling SOC determined in step S2 for a tank being filled or waiting to be filled at a dispensing terminal 1-9 is equal to the degree of use of the terminal 1-9 in question. Thus, based on the degree of use of a given terminal 1-9, the method 200 makes it possible to estimate the future availability of this terminal 1-9.

The following text illustrates two implementation examples of the distribution method 200 according to the invention, in relation to FIG. 1 and FIG. 2.

In FIG. 1, the first group 30A of terminals 1-3 has two free terminals (No. 2 and 3) and a single terminal (No. 1) occupied by a tank being filled. At the time t₀, this tank displays a degree of filling SOC of 25%. The occupancy of this first group 30A of terminals 1-3 is therefore 8%.

The second group 30B of terminals 4-6 has a free terminal (No. 6) and two terminals (Nos. 4 and 5, respectively) that are occupied by two tanks which are at the end of filling and therefore display a maximum degree of filling SOC (100%). However, according to the method introduced by the invention, a zero degree of filling SOC (SOC=0%) is assigned to these tanks which are at the end of filling. The occupancy of this second group 30B of terminals 4-6 is 0%.

The third group 30C of terminals 7-9 has a free terminal (No. 7) and two terminals (Nos. 8 and 9) that are occupied by two tanks, the first of which is waiting to be filled and the second is being filled. The tank connected to terminal No. 8 displays a degree of filling SOC of 30%. The tank connected to terminal No. 9 displays a degree of filling SOC of 50%. With a zero degree of filling SOC (SOC=0%) assigned to the virtual tank connected to terminal No. 7, the occupancy of this third group 30C of terminals 7-9 is 27%.

A comparison between the different degrees of use of the groups 3A, 3B, 3C of terminals 1-3, 4-6, 7-9 shows that the second group 30B of terminals 4-6 is the one that displays the lowest occupancy. Thus, the next tank in the queue will be directed to this second group 30B of terminals, where filling can begin without delay.

Sending the next tank to the first group 30A or the third group 30C would have led to an additional waiting time before the start of filling.

This is because, although the first group 30A of terminals 1-3 and the third group 30C of terminals 7-9 each have at least one free terminal capable of immediately receiving a tank, no new filling can actually be undertaken at these groups 30A, 30C of terminals 1-3, 7-9 given that each of these groups 30A, 30C is already occupied by a tank being filled.

The example illustrated in FIG. 2 is identical to the one illustrated in FIG. 1, except with regard to the second group 30B of terminals 4-6.

In this example, all the terminals 4-6 of the second group 30B are occupied by tanks at the end of filling, and no terminal is free. The occupancy of this second group 30B of terminals 4-6 is therefore 0%.

Moreover, it is apparent that the second group 30B of terminals cannot be selected to receive the next tank because of the lack of available terminals. Only the first group 30A and the third group 30C are potential candidates for receiving a next tank to be filled.

A comparison between the first group 30A of terminals 1-3 and the third group 30C of terminals 7-9 shows that the first group 30A displays the lowest degree of use. Thus, the first group 30A will be selected to receive the next tank.

The choice between the free terminal No. 2 and the free terminal No. 3 of the first group 30A can be dictated by the order of these terminals. For example, the lower rank terminal (terminal No. 2) may be chosen as the terminal for receiving the next tank.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. A method for distributing a queue of tanks to be filled in a station for dispensing a pressurized gas, the station comprising at least one source of pressurized gas, a plurality of dispensing terminals that are fluidically connected to the at least one gas source and are each configured to be connected to and to supply a respective tank, a plurality of separate header pipes that are connected upstream to the at least one gas source and downstream to a group of terminals via parallel branches, the station also comprising a control unit configured to switch on, from each group of terminals, only one terminal at a time in order to fill only one tank at a time, the method comprising the following steps:
for each terminal to which a tank waiting to be filled or being filled is connected, determining S2 at a time (t₀) a specific degree of filling of said tank;
for each group of terminals comprising at least one free terminal, determining S3 at the time (t₀) a degree of use of said group of terminals from an average degree of filling of the tanks connected to said group of terminals, which is equal to the average of the specific degrees of filling of the tanks connected to said group of terminals;
from the groups of terminals having at least one free terminal, selecting S4 a group having the lowest degree of use as the group for receiving a next tank; and
with regard to the group of terminals selected in the selecting step S4, selecting S5 one of the free terminals as the terminal for receiving the next tank.

2. The method according to claim 1, wherein the average degree of filling calculated with regard to each group of terminals is a ratio between: i) the sum of the specific degrees of filling of the tanks connected to said group of terminals and waiting to be filled or being filled, and ii) the total number of terminals forming the group of terminals.

3. The method according to claim 1, comprising, for any tank connected to a terminal and at the end of filling, that is to say having reached a maximum specific degree of filling at the time (t₀), a step S1a of assigning a zero specific degree of filling to said tank, the degree of use of the group of terminals to which said tank is connected being determined from an average degree of filling calculated on the basis of the specific degree or degrees of filling determined in step S2 and on the basis of the zero specific degree or degrees of filling assigned in step S1a.

4. The method according to claim 2, comprising, for any free terminal, a step S1b of assigning a zero specific degree of filling corresponding to an empty virtual tank connected to said terminal, the degree of use of the group of terminals to which said free terminal belongs being determined from an average degree of filling calculated on the basis of the specific degree or degrees of filling determined in step S2 and on the basis of the zero specific degree or degrees of filling assigned in step S1b.

5. The method according to claim 1, wherein, for any tank connected to a terminal and waiting to be filled or being filled, the specific degree of filling at the time (t₀) corresponds to a ratio between a value of the density of the gas present in said tank at the time (t₀) and a reference value of the density of the gas corresponding to said completely filled tank.

6. The method according to claim 5, wherein the value of the density of the gas in the tank at the time (t₀) is determined from the pressure and the temperature of the gas that are measured in the tank using, respectively, a pressure sensor and a temperature sensor that are present in the tank.

7. The method according to claim 5, wherein the value of the density of the gas in the tank at the time (t₀) is determined from the pressure and the temperature of the gas that are measured at the terminal to which the tank is connected.

8. The method according to claim 7, wherein the value of the density of the gas in the tank at the time (t₀) takes into account: i) a first corrective factor representing the pressure drops associated with a supply hose fitted to the terminal to which the tank is connected, and/or ii) a second corrective factor taking into account the difference between the ambient temperature and a change in the temperature inside the tank.

9. The method according to claim 1, wherein each header pipe is provided with at least one member for compressing the gas.

10. The method according to claim 1, wherein the groups of terminals each comprise an identical number of terminals.

11. The method according to claim 1, wherein the control unit comprises a set of valves distributed in the region of the terminals, and an electronic system provided with a microprocessor.
